(19) United States
(12) Patent Application Publication
(10) Pub. No.: US 2017/0185904 A1
(43) Pub. Date: Jun. 29, 2017

(54) METHOD AND APPARATUS FOR FACILITATING ON-DEMAND BUILDING OF PREDICTIVE MODELS

(71) Applicant: 24/7 Customer, Inc., Campbell, CA (US)

(72) Inventors: Dhanesh PADMANABHAN, Bangalore (IN); Ravishankar RAJAGOPALAN, Bangalore (IN); Aravind Kumar Yadav ABBENA, Hyderabad (IN); Mohd Suaib DANISH, Bangalore (IN); Aditi VISWANATHAN, Bangalore (IN); Samik RAYCHAUDHURI, Bangalore (IN)

(21) Appl. No.: 15/389,170

(22) Filed: Dec. 22, 2016

Related U.S. Application Data
(60) Provisional application No. 62/272,541, filed on Dec. 29, 2015.

(51) Int. Cl. G06N 5/04; G06N 99/00

(52) U.S. Cl. CPC G06N 5/04; G06N 99/005

(57) ABSTRACT

A computer-implemented method and an apparatus facilitate on-demand building of predictive models. Data corresponding to a plurality of customers is retrieved from data sources and a training data sample and a testing data sample are generated from the retrieved data. Variables for developing the predictive model are identified from the retrieved data and are subjected to any of structured categorical variable binning, unstructured categorical variable binning, and numeric variable binning to generate transformed variables. The transformed variables and the training data sample are used to develop predictive models. The developed predictive models are tested using the testing data sample and scores are generated corresponding to the developed predictive models. A predictive model is selected from among the developed predictive models based on the scores. The selected predictive model is published on a prediction platform to facilitate prediction of outcomes related to customers of the enterprise.

### CROSS REFERENCE TO RELATED APPLICATIONS

This application claims priority to U.S. provisional patent application Ser. No. 62/272,541, filed Dec. 29, 2015, which is incorporated herein in its entirety by this reference thereto.

### TECHNICAL FIELD

The invention generally relates to machine learning models used by enterprises for customer-related predictions and more particularly to a method and apparatus for facilitating on-demand building of predictive models.

### BACKGROUND

Enterprises typically use a variety of machine learning algorithms to predict outcomes or events related to their customers. For example, using a machine learning algorithm, the enterprise may predict that a customer, who is currently browsing an enterprise Website, intends to buy a particular product or not. Such machine learning algorithms are referred to herein as ‘predictive models.’

In some example scenarios, information related to a customer's activity on an enterprise interaction channel, such as the enterprise Website for example, may be captured and provided to a predictive model to predict the customer's intentions. For example, information such as Web pages visited, hyperlinks accessed, images viewed, mouse roll-over events, time spent on each Web page, and the like, may be captured from the activity of the customer on the Website. Such information may then be provisioned to a predictive model, which may then predict the intention of the customer.

The prediction of a customer's intention may enable the enterprise to anticipate the customer's actions and proactively perform suitable actions to improve the chances of a sale or to provide an enriched customer service experience to the customer. For example, using a predictive model, the enterprise may predict that a customer needs assistance and may proactively offer assistance in the form of a chat interaction with an agent to the customer.

The currently available predictive models, however, have several limitations. For example, conventional predictive models are incapable of consuming different forms of data, such as data in structured or unstructured form, for example speech and text data, to predict outcomes. Typically, end users of the predictive models have to write proprietary code for processing different forms of data and additional custom code to port the proprietary code to the predictive models. The conventional predictive models also lack core machine learning services that can deal with large-scale data with high cardinality variables and highly unstructured information. Further, current solutions enable development of predictive models for pre-defined specific purposes and do not provide flexibility to an end user or a client application to build predictive models with different requirements in an on-demand manner.

Therefore, there is a need to overcome shortcomings of the current solutions and provide an efficient solution for building of predictive models that can be invoked in an on-demand or scheduled manner for customer-related prediction purposes.

### SUMMARY

An embodiment of the invention provides a computer-implemented method for facilitating on-demand building of predictive models. The method receives, by a processor, from a user at least one specification for developing at least one predictive model, and an input identifying one or more data sources that store data related to a plurality of customers of an enterprise. The method retrieves, by the processor, the data related to the plurality of customers from the one or more data sources. The method generates, by the processor, a training data sample and a testing data sample from the retrieved data. The method performs, by the processor, at least one of structured categorical variable binning, unstructured categorical variable binning, and numeric variable binning to generate transformed variables from variables identified for developing the at least one predictive model. The method develops, by the processor, one or more predictive models based, at least in part, on the transformed variables and the training data sample. The method generates, by the processor, at least one score corresponding to each predictive model from among the one or more predictive models based, at least in part, on the testing data sample. The method publishes, by the processor, a predictive model on a prediction platform to facilitate prediction of outcomes related to customers of the enterprise. The predictive model is selected from among the one or more predictive models based on the at least one score associated with each predictive model.

In another embodiment of the invention, an apparatus for facilitating on-demand building of predictive models includes an input/output (I/O) module and a communication interface communicably coupled with the I/O module. The I/O module is configured to receive from a user at least one specification for developing at least one predictive model, and an input identifying one or more data sources storing data related to a plurality of customers of an enterprise. The communication interface is configured to facilitate retrieval of the data related to the plurality of customers from the one or more data sources. The apparatus further includes at least one processor and a memory. The memory stores machine executable instructions therein that, when executed by the at least one processor, cause the apparatus to generate a training data sample and a testing data sample from the retrieved data. The apparatus performs at least one of structured categorical variable binning, unstructured categorical variable binning, and numeric variable binning to generate transformed variables from variables identified for developing the at least one predictive model. The apparatus develops one or more predictive models based, at least in part, on the transformed variables and the training data sample. The apparatus generates at least one score corresponding to each predictive model from among the one or more predictive models based, at least in part, on the testing data sample. The apparatus publishes a predictive model on a prediction platform to facilitate prediction of outcomes related to customers of the enterprise. The predictive model is selected from among the one or more predictive models based on the at least one score associated with each predictive model.

Another embodiment of the invention provides an apparatus for facilitating on-demand building of predictive models. The apparatus includes an input/output (I/O) module and a communication interface communicably coupled with the I/O module. The I/O module is configured to receive from a user at least one specification for developing at least one predictive model, and an input identifying one or more data sources storing data related to a plurality of customers of an enterprise. The communication interface is configured to facilitate retrieval of the data related to the plurality of customers from the one or more data sources. The apparatus further includes a data ingestion module, a transformation module, a model building module, a model validating module, and a model publishing module. The data ingestion module is configured to generate a training data sample and a testing data sample from the retrieved data. The transformation module is configured to perform at least one of structured categorical variable binning, unstructured categorical variable binning, and numeric variable binning to generate transformed variables from variables identified for developing the at least one predictive model. The model building module is configured to develop one or more predictive models based, at least in part, on the transformed variables and the training data sample. The model validating module is configured to generate at least one score corresponding to each predictive model from among the one or more predictive models based, at least in part, on the testing data sample. The model publishing module is configured to publish a predictive model on a prediction platform to facilitate prediction of outcomes related to customers of the enterprise. The predictive model is selected from among the one or more predictive models based on the at least one score associated with each predictive model.

### BRIEF DESCRIPTION OF THE FIGURES

FIG. 1 is a block diagram of an apparatus configured to facilitate on-demand building of predictive models in accordance with an embodiment of the invention;

FIG. 2 shows a block diagram for illustrating example operations executed by the apparatus of FIG. 1 for facilitating on-demand building of predictive models in accordance with an embodiment of the invention;

FIG. 3 is a block diagram showing a plurality of modules for facilitating on-demand building of predictive models in accordance with an embodiment of the invention;

FIG. 4 shows a block diagram for illustrating API actions executed by a data ingestion module in response to user inputs received from the I/O module in accordance with an embodiment of the invention;

FIG. 5 shows a block diagram for illustrating API actions executed by a transformation module in response to inputs for various types of algorithmic transformations in accordance with an embodiment of the invention;

FIG. 6 shows a block diagram for illustrating API actions executed by a model building module and a model validating module in response to inputs corresponding to train and predict modes in accordance with an embodiment of the invention;

FIG. 7 shows a block diagram for illustrating API actions executed by a model publishing module, a model monitoring module, and a model retraining module in accordance with an embodiment of the invention; and

FIG. 8 is an example flow diagram of a method for facilitating on-demand building of predictive models in accordance with an embodiment of the invention.

### DETAILED DESCRIPTION

The detailed description provided below in connection with the appended drawings is intended as a description of the present invention and is not intended to represent the only forms in which the present invention may be constructed or used. However, the same or equivalent functions and sequences may be accomplished differently.

Prediction of intentions, next actions, and such other outcomes of customers enable enterprises to take appropriate measures to influence chances of a sale or improve the customer service experience for its customers. Accordingly, enterprises employ a variety of machine learning algorithms for customer-related predictions. Currently available machine learning algorithms, which are also referred to herein as predictive models, are generally trained for a specific purpose. These models are not flexible enough to be called or invoked for a variety of prediction requests. Further, these models are generally designed to handle structured data, such as data collated corresponding to customer activity on an enterprise Website. However, a customer may interact with an enterprise using various other means such as, for example, by chatting with a virtual agent or by verbally communicating with an human agent or an Interactive Voice Response (IVR) system associated with the enterprise, and the like. The speech data or the chat logs, as such, constitute unstructured data and the models are incapable of processing such data without modification or addition of external plug-ins.

Various embodiments of the invention provide methods and apparatuses for facilitating on-demand building of predictive models. More specifically, the embodiments disclosed herein enable users, such as enterprise users, to develop predictive models on-demand and use the predictive models to suit their requirements. As such, the enterprise users may invoke ‘prediction capabilities’ as an on-demand service, and by providing specifications indicating desired output to the predictive models, the enterprise users may acquire the desired prediction of outcomes related to its customers.

Moreover, the developed predictive models are capable of processing structured data, unstructured data, and numerical data without requiring any proprietary code to accomplish the processing of such data. Moreover, the predictive models are also capable of handling variables, which are associated with high cardinality, for prediction purposes.

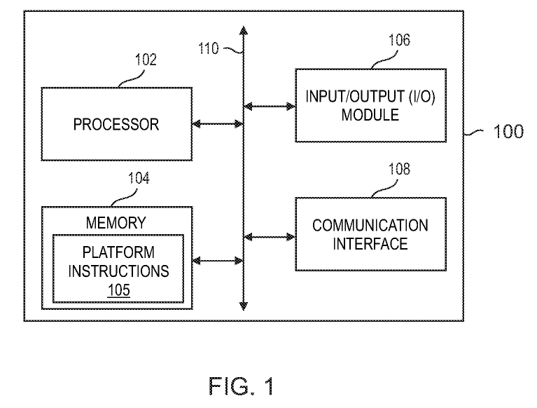

Various aspects of the invention are explained hereinafter with reference to FIGS. 1 to 8.

FIG. 1 is a block diagram of an apparatus 100 configured to facilitate on-demand building of predictive models in accordance with an embodiment of the invention. The term ‘predictive model’ as used herein refers to machine learning software, which is configured to predict outcomes for a given set of inputs. In an illustrative example, information related to customer activity on an enterprise Website may be provided to the predictive model and the predictive model may be configured to predict if the customer intends to make a purchase transaction during the ongoing visit to the enterprise Website or not. The term ‘building a predictive model’ or ‘developing a predictive model’ as used interchangeably herein refers to creating machine learning software and training the machine learning software to intelligently link or match input data to stored patterns in memory to predict outcomes and events such as, for example, a next action of a customer on the enterprise interaction channel. In an illustrative example, a customer may have requested agent assistance after visiting a particular sequence of Web pages on the enterprise Website. Accordingly, if another customer exhibits a similar online behavior, such as visiting the same sequence of Web pages, then the predictive model may be configured to predict that the customer may seek agent assistance in near future and accordingly may suggest proactively offering agent assistance to the customer to improve the customer's interaction experience. The sequence of Web pages visited by the customer in the above example is an illustrative example of variables considered for prediction purposes. It is noted that the predictive models are configured to consider several variables for predicting outcomes for customers of the enterprise.

Further, the term ‘customer’ as used herein refers to either an existing user or a potential user of enterprise offerings, such as products, services, and/or information. Moreover, the term ‘customer’ of the enterprise may refer to an individual, a group of individuals, an organizational entity, etc. The term ‘enterprise’ as used herein may refer to a corporation, an institution, a small/medium sized company, or even a brick and mortar entity. For example, the enterprise may be a banking enterprise, an educational institution, a financial trading enterprise, an aviation company, a consumer goods enterprise, or any such public or private sector enterprise.

The apparatus 100 includes at least one processor, such as a processor 102, and a memory 104. It is noted that although the apparatus 100 is depicted to include only one processor, the apparatus 100 may include any number of processors therein. In an embodiment, the memory 104 is capable of storing machine executable instructions, referred to herein as platform instructions 105. Further, the processor 102 is capable of executing the platform instructions 105.

In an embodiment, the processor 102 may be embodied as a multi-core processor, a single core processor, or a combination of one or more multi-core processors and one or more single core processors. For example, the processor 102 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 102 may be configured to execute hard-coded functionality. In an embodiment, the processor 102 is embodied as an executor of software instructions, wherein the instructions may specifically configure the processor 102 to perform the algorithms and/or operations described herein when the instructions are executed.

The memory 104 may be embodied as one or more volatile memory devices, one or more non-volatile memory devices, and/or a combination of one or more volatile memory devices and non-volatile memory devices. For example, the memory 104 may be embodied as magnetic storage devices, such as hard disk drives, floppy disks, magnetic tapes, etc.; optical magnetic storage devices, e.g. magneto-optical disks; CD-ROM (compact disc read only memory); CD-R (compact disc recordable); CD-R/W (compact disc rewritable); DVD (Digital Versatile Disc); BD (BLU-RAY® Disc); and semiconductor memories, such as mask ROM, PROM (programmable ROM), EPROM (erasable PROM), flash memory, RAM (random access memory), etc. In at least one example embodiment, the memory 104 stores a library of machine learning algorithms that may be trained to develop predictive models, as will be explained in detail later. Some non-exhaustive example of machine learning algorithms stored in the memory 104 include algorithms related to Logistic Regression, Modified Naïve Bayes, Decision Tree, Random Forest, Support Vector Machine, and Xgboost.

The apparatus 100 also includes an input/output module 106 (hereinafter referred to as ‘I/O module 106’) and at least one communication interface such as the communication interface 108. The I/O module 106 is configured to be in communication with the processor 102 and the memory 104. The I/O module 106 may include mechanisms configured to receive inputs from the user of the apparatus 100. The I/O module 106 is also configured to facilitate provisioning of an output to a user of the apparatus 100. In an embodiment, the I/O module 106 may be configured to provide a user interface (UI) that provides options or any other display to the user. Examples of the I/O module 106 include, but are not limited to, an input interface and/or an output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like. In an example embodiment, the processor 102 may include I/O circuitry configured to control at least some functions of one or more elements of the I/O module 106, such as, for example, a speaker, a microphone, a display, and/or the like. The processor 102 and/or the I/O circuitry may be configured to control one or more functions of the one or more elements of the I/O module 106 through computer program instructions, for example, software and/or firmware, stored on a memory, for example, the memory 104, and/or the like, accessible to the processor 102.

The communication interface 108 is configured to communicate with a plurality of enterprise related interaction channels. Some non-limiting examples of the enterprise related interaction channels including a Web channel, i.e. an enterprise Website; a voice channel, i.e. voice-based customer support; a chat channel, i.e. a chat support; a native mobile application channel; a social media channel; and the like. In at least one example embodiment, the communication interface 108 may include several channel interfaces to facilitate communication with the plurality of enterprise related interaction channels. Each channel interface may be associated with a respective communication circuitry such as for example, transceiver circuitry including antenna and other communication media interfaces to connect to a wired and/or wireless communication network. The communication circuitry associated with each channel interface may, in at least some example embodiments, enable transmission of data signals and/or reception of signals from remote network entities, such as Web servers hosting enterprise Website or a server at a customer support or service center configured to maintain real-time information related to interactions between customers and agents.

In some embodiments, the communication interface 108 may also be configured to receive information from the plurality of devices used by the customers. To that effect, the communication interface 108 may be in operative communication with various customer touch points, such as electronic devices associated with the customers, Websites visited by the customers, devices used by customer support representatives, for example voice agents, chat agents, IVR systems, in-store agents, and the like, engaged by the customers, and the like. In at least some embodiments, the communication interface 108 may include relevant application programming interfaces (APIs) configured to facilitate reception of information related to customer communication from the customer touch points.

In an embodiment, various components of the apparatus 100, such as the processor 102, the memory 104, the I/O module 106, and the communication interface 108 are configured to communicate with each other via or through a centralized circuit system 110. The centralized circuit system 110 may be various devices configured to, among other things, provide or enable communication between the components (102-108) of the apparatus 100. In certain embodiments, the centralized circuit system 110 may be a central printed circuit board (PCB) such as a motherboard, a main board, a system board, or a logic board. The centralized circuit system 110 may also, or alternatively, include other printed circuit assemblies (PCAs) or communication channel media.

The apparatus 100 as illustrated and hereinafter described is merely illustrative of an apparatus that could benefit from embodiments of the invention and, therefore, should not be taken to limit the scope of the invention. The apparatus 100 may include fewer or more components than those depicted in FIG. 1. In an embodiment, the apparatus 100 may be included within a prediction platform. In some other embodiments, the apparatus 100 may be external to the prediction platform and may be communicably associated with the prediction platform to facilitate prediction of outcomes related to customers of the enterprise. The prediction platform may be implemented using a mix of existing open systems, proprietary systems, and third party systems. In another embodiment, the prediction platform may be implemented completely as a set of software layers on top of existing hardware systems.

In an embodiment, one or more components of the apparatus 100 may be deployed in a Web server. In another embodiment, the apparatus 100 may be a standalone component in a remote machine connected to a communication network and capable of executing a set of instructions (sequential and/or otherwise) to facilitate on-demand building of predictive models. Moreover, the apparatus 100 may be implemented as a centralized system or, alternatively, the various components of the apparatus 100 may be deployed in a distributed manner while being operatively coupled to each other. In an embodiment, one or more functionalities of the apparatus 100 may also be embodied as a client within devices, such as customers' devices. In another embodiment, the apparatus 100 may be a central system that is shared by or accessible to each of such devices.

The building of predictive models by the apparatus 100 is hereinafter explained with reference to a single predictive model built in response to an enterprise user's requirement. The apparatus 100 may be caused to facilitate building of several predictive models for a plurality of enterprise users for a variety of user requirements.

In at least one example embodiment, the processor 102 is configured to, with the content of the memory 104, cause the apparatus 100 to receive at least one specification for developing at least one predictive model from a user. The term ‘user of the apparatus’ as used herein may refer to a human representative of the enterprise, for example a software manager, tasked with predicting outcomes for plurality of customers of the enterprise. In an embodiment, a specification may relate to a problem definition for developing the predictive model. The problem definition may be indicative of an objective of the user for developing the predictive model. More specifically, the problem definition may describe a problem that the user intends to solve using the predictive model. Some non-exhaustive examples of user objectives for building the predictive models include customer intent prediction, spam or fraud detection (for e-commerce applications), customer credit risk modeling or customer lead scoring (for traditional applications), and the like. A simplified example of a problem definition framed by a user may be “Build a machine learning model for online visitors capable of predicting a propensity that any particular visitor would purchase in the current Web session if offered chat assistance during the session.”

In one embodiment, the apparatus 100 may also be caused to receive a specification in the form of a discrete outcome to be predicted for each customer by the predictive model. In an illustrative example, the user may wish to solve a classification problem by building a model to predict a discrete outcome such as whether a customer will buy or not-buy during a current interaction, whether a particular communication is spam or not spam, and the like. In addition to discrete outcomes such as the buy/no-buy outcome, the spam/no-spam communication outcome, discrete outcomes such as whether the customer is a high risk/low risk customer, a potential lead or a stump, and the like, may also be predicted.

Further, in at least one example embodiment, the apparatus 100 may also receive a specification suggestive of one or more customer segments to be considered for prediction by the predictive model from the user. Some non-limiting examples of segments may include a segment of customers using mobile devices versus those who use a desktop; a segment of customers who are repeat visitors to enterprise interaction channels versus those who are non-repeat visitors to the enterprise interaction channels; a segment including existing customers versus new customers; and the like.

In an embodiment, the specification corresponding to the one or more customer segments to be considered may further include instructions corresponding to pre-conditions for individual segments. In an illustrative example, a pre-condition for segment corresponding to online visitors may be a qualification criterion such as, for example, to limit the application of the model to non-bouncers or visitors visiting specific (or predefined) Web pages, or to exclude customers who have explicitly opted out of personalized treatment offers, and the like.

In some embodiments, a user of the apparatus 100 may also specify data sampling options for model building and validation through specification of a sampling ratio. For example, the user may provide a ratio for sampling data corresponding to plurality of customers of the enterprise to generate the training data sample and the testing data sample. The provisioning of the ratio, as the specification and subsequent generation of the training data sample and the testing data sample will be explained in further detail later.

In an illustrative example, the I/O module 106 of the apparatus 100 may be configured to display a user interface (UI), for example a GUI showing options to the user to enable the user to provide the one or more specifications. For example, the UI may display a drop-down menu showing various problem definitions and the user may provide a selection input for a problem definition to provision the specification describing the problem to be solved by building the predictive model. Alternatively, the UI may display a text box capable of receiving textual input specifying the problem to be solved from the user. In some example embodiments, upon receiving selection of the problem definition, the apparatus 100 may be caused to display another UI showing options along with respective selection boxes capable of receiving a tick or check input for enabling selection of discrete outcome to be predicted and the segments to be considered for prediction purposes. It is noted that the options may be provided based on the user specification related to the problem definition. Furthermore, a UI displaying text boxes and capable of receiving numerical or text input related to the sampling ratio may also be displayed to the user by the apparatus 100 for receiving corresponding user specification.

In at least one example embodiment, the apparatus 100 may further be caused to receive an input identifying one or more data sources for procuring data related to a plurality of customers of an enterprise. Most enterprises typically deploy several data gathering servers to capture information related to its customers. To that effect, the data gathering servers may be in operative communication with enterprise interaction channels, such as Websites, interactive voice response (IVR) systems, social media, customer support centers, and the like. The capture of information related to the customers in the data gathering servers is further explained below.

In an illustrative example, content pieces such as images, hyperlinks, URLs, and the like, that are displayed on an enterprise Website may be associated with Hypertext Markup Language (HTML) tags or JavaScript tags that are configured to be invoked upon user selection of tagged content. The information corresponding to the customer's activity on the enterprise Website may then be captured by recording an invoking of the tags in a Web server, i.e. a data gathering server, hosting the enterprise Website. In an illustrative example, information captured corresponding to a customer's interaction with an enterprise Website may include information, such as Web pages visited on the website, time spent on each Web page visited, images viewed, hyperlinks accessed, mouse roll-over events, and the like.

In another illustrative example, voice agents or chat agents may associate on-going conversational content with appropriate tags, which may enable capture of information, such as category of customer concern, concern resolution status, agent information, call transfers if any, time of the day and/or the day of the week for the interaction, and the like. The tagged information may be recorded in a data gathering server associated with the customer support center associated with the enterprise voice or chat agents.

In some embodiments, the data gathering servers may also be in operative communication with personal devices of the customers, for example in remote communication with native mobile applications, voice assistants, etc. included within the personal devices of the customers, to capture information related to the customers. Accordingly, the data gathering servers may capture interaction related information and in some cases, personal information such as name, billing address, email accounts, contact details, location information, social media accounts, etc. for each customer. The data gathering servers may capture such information related to plurality of customers of the enterprise.

In at least one example embodiment, upon receiving an input identifying one or more data sources, for example server addresses of data gathering servers, the processor 102 of the apparatus 100, using the communication interface 108, may be configured to request the data sources for data corresponding to the plurality of customers. Further, the communication interface 108 may be configured to receive data and store the retrieved data in the memory 104. In at least one example embodiment, the communication interface may include several application programming interfaces (APIs), such as representational state transfer (REST) APIs for example, that are configured to provision the retrieved data corresponding to the plurality of customers, in an un-delimited format, to the memory 104 for storage purposes. In some embodiments, the memory 104 may include a data store, such as a Hadoop Distributed File System (HDFS), or other storage as a service solutions, to store the retrieved data.

In some embodiments, in addition to identifying the data sources, the input from the user may also specify a schema for data retrieval, such as a tabular form for example, a date range, and other such instructions.

The data retrieved corresponding to the plurality of customers of the enterprise may include structured data, unstructured data, and/or numerical data. In an illustrative example, the data retrieved corresponding to customer's activity on the enterprise Website may configure structured data. For example, data related to whether a particular Web page was visited or not, a specific image was clicked upon or not, and the like, may be captured in a structured manner for the plurality of customers visiting the Website. However, data retrieved corresponding to customer's voice conversations or chat logs may differ from one customer to another and, as such, configure the unstructured data. The retrieved data may further include numerical information, such as time of the day, date of the month, phone number, credit card information, and the like. Accordingly, the data retrieved corresponding to the plurality of customers of the enterprise may include information captured in various forms.

In at least one example embodiment, the retrieved data may be in accordance with the segment specifications provided by the user. Subsequent steps for developing predictive models may be executed separately for each segment. However, for the sake of simplicity, the development of predictive models is explained assuming only one segment or an unsegmented data retrieval.

In at least one example embodiment, the processor 102 is configured to, with the content of the memory 104, cause the apparatus 100 to generate a training data sample and a testing data sample from the retrieved data. As explained above, the user of the apparatus 100 may provide an input related to a sampling ratio. In at least one example embodiment, the apparatus 100 may be caused to split the retrieved data to generate the training data sample and the testing data sample. In a simplified illustrative example, the user of the apparatus may provide the sampling ratio as 2:1. For retrieved data corresponding to 1500 customers of the enterprise, the apparatus 100 may be caused to reserve data corresponding to 1000 customers as a training data sample, and the data corresponding to the remaining 500 customers may be reserved as testing data sample. In at least one example embodiment, the training data sample is used for training or developing the predictive model, whereas the testing data sample is used for testing and/or validating the developed predictive model. The sampling ratio of 2:1 and the retrieved data corresponding to 1500 customers are mentioned herein for illustration purposes and the user may specify the sampling ratio in any other form, for example a 60:40 ratio etc. Moreover, the retrieved data may correspond to fewer or more number of customers of the enterprise.

In at least one example embodiment, the processor 102 is configured to, with the content of the memory 104, cause the apparatus 100 to identify variables that may be used for developing the predictive models. In some embodiments, the retrieved data may be in an organized form, such as tabulated in columns. As such, the column headings may serve as the pre-defined categorical variables. For example, data captured corresponding to an online visitor's journey to an enterprise Website may include information such as pages visited, time spent on each Web page, sequence of Web pages visited, browser/operating system associated with Web access, and the like. Such information may be captured for each online visitor and stored, for example in a tabular format. The column or row headings in the table may serve as the predefined categorical variables to be used for developing the predictive models. The variables identified from structured data are referred to herein as structured categorical variables. In some example embodiments, the agent tag entries for chat/speech logs may serve as the categorical variables. The variables identified from unstructured data are referred to herein as unstructured categorical variables. Similarly, variables corresponding to numerical data are referred to herein as numeric variables. In some embodiments, the user may also specify custom variables, for example in form of SQL functions. Some of the SQL functions supported by the processor 102, and that may be selected by the user include ‘log’, ‘timestamp’, ‘date’, and the like. Accordingly, the apparatus 100 may be caused to identify a plurality of variables that may be used for developing predictive models.

In at least one example embodiment, the processor 102 is configured to, with the content of the memory 104, cause the apparatus 100 to perform data transformation. In at least one example embodiment, data transformation includes performing structured categorical variable binning, unstructured categorical variable binning, and/or numeric variable binning to generate transformed variables from variables identified for developing the at least one predictive model. Binning is the process of reducing the cardinality of the variable by grouping similar values into a bucket. For binning, the user may provide a list of variables to be binned along with type of binning, depending on whether the variable is numeric or categorical and the number of bins. For example, one or more variables corresponding to structured categorical variables from among the identified variables may be subjected to a clustering algorithm, such as a hierarchical clustering algorithm, for performing the structured categorical variable binning to reduce cardinality associated with the structured categorical variables. Similarly, unstructured data from among the retrieved data may be converted to structured data using natural language language algorithms, such as those associated with text-based pre-processing. The categorical variables generated from such converted structured data may then be subjected to clustering algorithms for performing unstructured categorical variable binning. Similarly, one or more variables corresponding to numeric variables from among the identified variables may be subjected to statistical algorithms and/or clustering algorithms to perform numeric variable binning and reduce cardinality associated with the numeric variables. In one embodiment, numeric variable binning may involve generating variable bins based on distribution of the data related to the plurality of customers, and identifying optimal splits in a numerical scale for binning the numerical data to facilitate generation of the transformed variables.

Such structured, unstructured, and numeric variable binning may generate transformed variables. In at least one example embodiment, the data corresponding to training data sample may be categorized based on the transformed variables to generate working datasets in transformed variables for prediction purposes.

In at least one example embodiment, the processor 102 is configured to, with the content of the memory 104, cause the apparatus 100 to develop one or more predictive models from the working datasets in transformed variables. The development of the predictive models is further explained below.

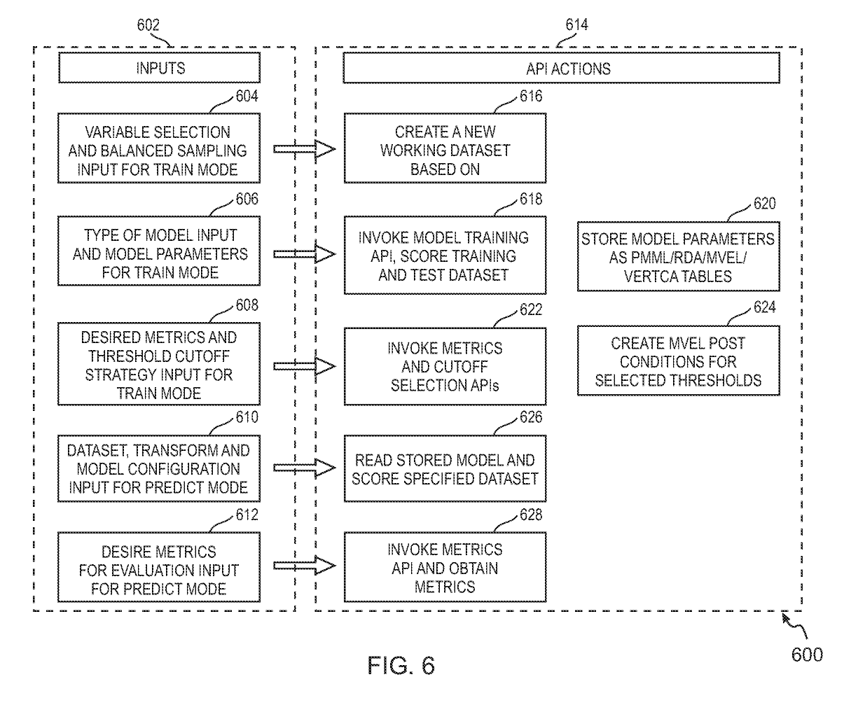

In an embodiment, the apparatus 100 may be caused to receive user input related to variables to be selected from among the transformed variables. The user input may also specify at least one type of machine learning algorithm to be used for developing the one or more predictive models, and metrics to be evaluated corresponding to developed predictive models. Accordingly, the apparatus 100 may be caused to retrieve machine learning algorithms of a type specified by the user from among a library of machine learning algorithms stored in the memory 104. For example, if the user specification corresponding to the type of machine learning algorithm relates to a classification task, such as predicting customer intention to determine whether the customer will make a purchase transaction during a current visit to the enterprise Website, then the processor 102 of the apparatus 100 may be caused to retrieve one or more machine learning algorithms, such as Logistic Regression, Modified Naïve Bayes, Decision Tree, Random Forest, Support Vector Machine, and Xgboost, which are capable of facilitating intent prediction. Further, the apparatus 100 may be caused to choose variables selected by the user and, accordingly, use chosen transformed variables and the working data sets from the training data sample to train the retrieved machine learning algorithms to develop one or more predictive models. The development of predictive models is explained in further detail later with reference to FIG. 6.

In at least one example embodiment, the processor 102 is configured to, with the content of the memory 104, cause the apparatus 100 to generate at least one score corresponding to each predictive model from among the one or more predictive models using the testing data sample. As explained above, the testing data sample may be used for evaluating the developed predictive models on metrics specified by the user. Such an evaluation may generate scores. Some examples of such metrics include, but are not limited to, metrics such as maximum accuracy, optimal cutoff, sensitivity, true positive rate, false positive rate, and F2-score. Furthermore, the developed predictive models may be scored based on evaluation of the models using simulated real-time usage behavior of the customers. The generation of scores for each developed predictive model is explained in further detail with reference to FIG. 6.

In at least one example embodiment, the processor 102 is configured to, with the content of the memory 104, cause the apparatus 100 to publish a predictive model from among the one or more predictive models on a prediction platform based on the scores associated with the predictive models. For example, the apparatus 100 may publish the predictive model with the highest score from among the developed predictive models. In at least one example embodiment, the model to be published may be optimized for user requirement using an optimization method selected from among FScore based optimization, Optimal probability threshold based optimization method, and Optimal probability and time of page threshold based optimization method. In at least one example embodiment, publishing the predictive model may imply generating the JavaScript code to be deployed in the real time prediction platform. The published predictive model may serve as the output in response to the input of user specification provided by the customer. The user may then use the published prediction model to predict outcomes related to customers of the enterprise.

In an embodiment, the apparatus 100 is further caused to monitor a real-time usage behavior of the published predictive model subsequent to the publishing of the predictive model. For example, monitoring the real-time usage behaviour may involve generating scores related to at least one metric from among Popularity Stability Index (PSI) and Variable Stability Index (VSI). The PSI tracks how the probability distribution of the model predictions change over time and VSI is used to evaluate the change in the variables used in the model.

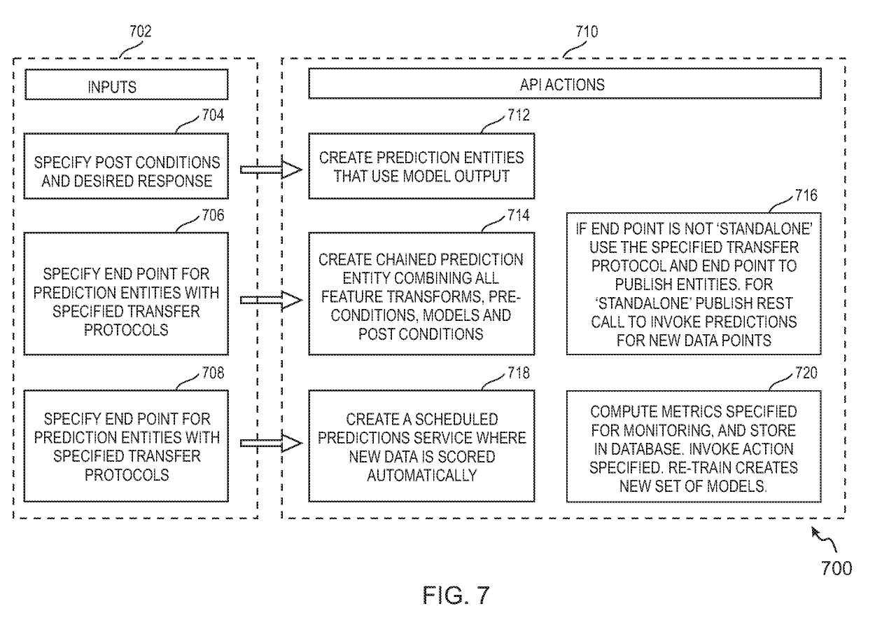

In an embodiment, the apparatus 100 is caused to trigger retraining of the published predictive model if a generated score corresponding to one of the PSI and the VSI is less than a predefined threshold value. For example, a PSI value of greater than 0.15, indicates a need for fine tuning of the current model or rebuilding of the model. In at least one example embodiment, the retraining of the predictive model is automated by the apparatus 100, which may be configured to runs all the steps from data transformation onwards and rebuilds the model. The monitoring and retraining of the predictive model is explained in further detail with reference to FIG. 7.

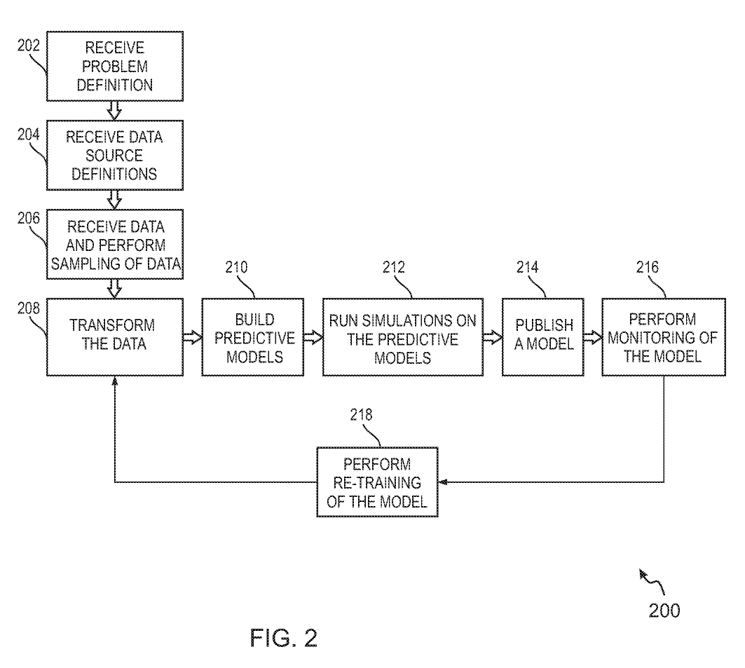

Referring now to FIG. 2, a block diagram 200 is shown for illustrating example operations executed by the apparatus 100 of FIG. 1 for facilitating on-demand building of predictive models in accordance with an embodiment of the invention. At operation 202, problem definition, for example a problem to be solved by building a model from data corresponding to the plurality of customers of the enterprise, is received from a user. At operation 204, data source definitions, i.e. user inputs identifying one or more data sources, are received from the user. As explained with reference to FIG. 1, the user may specify one or more data sources, for example server addresses, to provide the apparatus 100 with addresses of data stores from which to fetch or receive data related to a plurality of customers of an enterprise.

At operation 206, the apparatus 100 receives data corresponding to the plurality of customers of the enterprise from the one or more data sources and performs a sampling of the received data. The sampling of received data involves splitting of data into a training data sample and a testing data sample. As explained with reference to FIG. 1, the training data sample is used for building the model, whereas the testing data sample is used for validating the model.

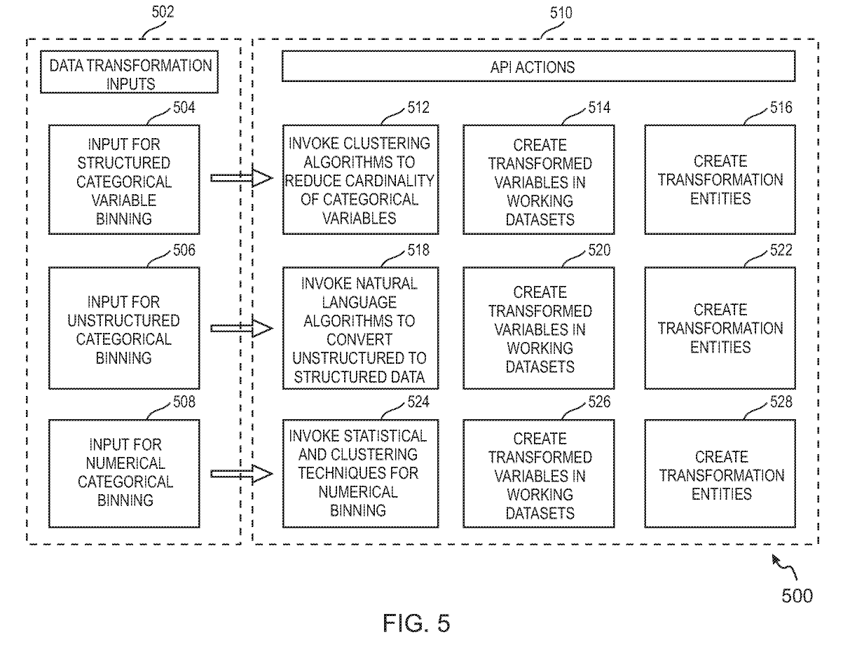

At operation 208, the apparatus 100 performs a transformation of data. The transformation of data is explained in detail later with reference to FIG. 5. At operation 210, one or more predictive models are built or trained using transformed data. At operation 212, the apparatus 100 runs simulations, which mimic real-time customer behavior, on the predictive model to generate scores and/or metrics corresponding to the predictive model. At operation 214, the apparatus 100 is configured to publish at least one predictive model, i.e. deploy at least one predictive model in a real-time prediction platform for predicting intentions of a plurality of customers of the enterprise. At operation 216, the apparatus 100 is configured to monitor a usage behavior of the published predictive model. At operation 218, the apparatus 100 is configured to retrain the published predictive model based on monitoring of the usage behavior upon publishing the predictive model in the real-time prediction platform.

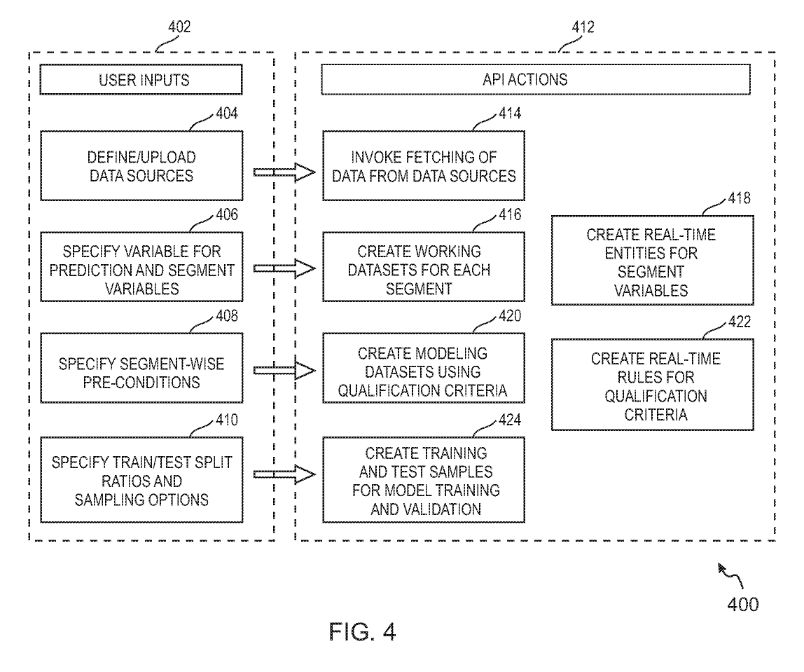

In at least one example embodiment, the operations executed by the apparatus 100 as explained using the block diagram 200 may be offered as an automated prediction workflow to several users to facilitate on-demand building of predictive models. Further, each step of the automated prediction workflow may be executed by the apparatus using one or more application programming interfaces (APIs) as will be explained with reference to FIGS. 4 to 7.

The on-demand building of predictive models by the apparatus 200 is explained hereinafter with reference to various modules implementing functionalities of the processor 102 of the apparatus 100. The apparatus components, modules, or units as described herein can be implemented using one processor or multiple processors or using one apparatus described in FIG. 1 or using multiple such apparatuses. In some embodiments, the processor 102 may be substituted by a combination of individual modules, such that the combination of individual modules perform similar functions as those that are performed by the processor 102.

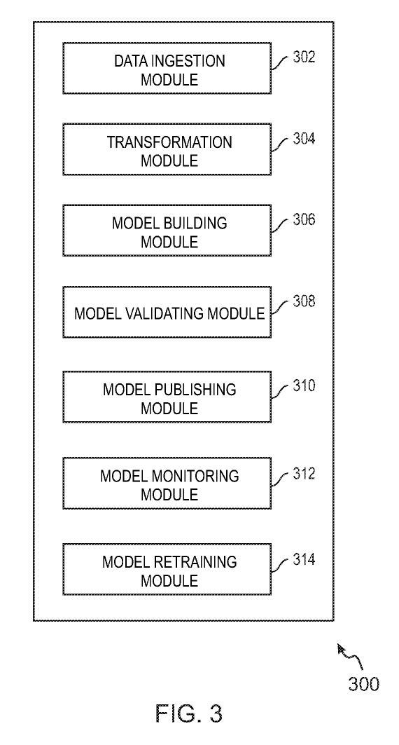

FIG. 3 is a block diagram 300 showing a plurality of modules for facilitating on-demand building of predictive models in accordance with an embodiment of the invention. In an embodiment, the plurality of modules shown in the block diagram 300 may, in effect, configure the processor 102 of the apparatus 100 for performing the actions as described herein. The plurality of modules depicted in the block diagram 300 includes a data ingestion module 302, a transformation module 304, a model building module 306, a model validating module 308, a model publishing module 310, a model monitoring module 312, and a model retraining module 314.

As explained with reference to FIG. 1, a user of the apparatus 100 may provide one or more specifications, such as specification related to the problem definition for building the predictive model, the discrete outcome to be predicted, the segments to be considered for prediction purposes, the sampling ratio, and the like. To provide such specifications, the user may provide input using the I/O module 106 of the apparatus 100. In an example embodiment, the data ingestion module 302 is configured to receive the user input from the I/O module 106 and perform at least one action in response to the received user input. In some embodiments, the one or more actions may be executed in form of API calls (hereinafter referred to as API actions) as exemplarily explained with reference to FIG. 4.

FIG. 4 shows a block diagram 400 for illustrating API actions executed by the data ingestion module 302 in response to user inputs received from the I/O module 106 in accordance with an embodiment of the invention. More specifically, the block diagram 400 depicts a column 402 including four blocks 404, 406, 408, and 410 representing user inputs for defining and/or uploading data sources, for specifying vertical-specific predictors, response and segment variables, for specifying pre-conditions (for example, qualification criteria) for each segment, and for specifying train/test split ratios and sampling options, respectively.

Further, the block diagram 400 depicts another column 412 including API actions executed by the data ingestion module 302 corresponding to each of those user inputs. For example, block 414 depicts that an API action, in response to the user input for define and/or upload data sources, may involve invoking fetching of data from user defined (or identified) one or more data sources, or uploaded data sources in the memory 104.

Block 416 depicts that API action, in response to specifying segment and outcome variables, corresponds to creating working datasets for each segment and for each outcome to be predicted. The term ‘creating working datasets for each segment’ implies separating the training sample for each segment that may be used for developing predictive models for the corresponding segment using the rest of the workflow (as explained with reference to FIG. 2). Block 418 depicts that API action, in response to specifying segment and outcome variables, corresponds to creating real-time entities for segment variables. The term ‘creating real-time entities’ implies publishing the user-defined segments as real-time equivalents.

Blocks 420 and 422 depict that API actions, in response to specifying segment-wise pre-conditions, may involve creating modeling datasets for each response using the qualification criteria and creating real-time rules for qualification criteria, respectively. For example, if a qualification criteria defined by the user refers to ‘targeting only the segment of desktop users’, then an example rule created for such a qualification criteria may suggest only evaluating the predictive model if the device of the customer is a desktop, or else the model evaluation may be skipped.

Block 424 depicts that API action, in response to specifying train and/or test split ratios and sampling options, may involve creating training and testing data samples for model training and validation. In an illustrative example, the train and/or test split ratio is used to split data, for example data in working datasets, into training data sample and testing data sample. As explained with reference to FIG. 1, the training data sample is used for building the model and the testing data sample is used for validating the model. In some example embodiments, out-of-time validation may also be used. Moreover, the sampling options dictate whether train, test, and/or validation are all required or not, and the date ranges for each of these.

Referring now to FIG. 3, in at least one example embodiment, the transformation module 304 is configured to perform transformation, i.e. step 208 of the process flow 200 explained with reference to FIG. 2, of the data. The term ‘transformation’ as used herein refers to the process of transforming data from a raw format to a format that can be used in the model.

In some embodiments, the transformation of data may involve creating columns for several structured, for example web page content; unstructured, for example, chat logs; and numeric variables. For example, a structured categorical variable may be a type of Web browser used for accessing the enterprise Website. A column for such a categorical variable may include browser name entries for each customer who has visited the enterprise Website in a chosen time frame, for example, within a week, month, a quarter, and the like. Another example of a structured categorical variable may be time spent of a Web page. An example of unstructured categorical variable may be type of customer concern, such as for example, concern conveyed by the customer during a chat or voice interaction with an agent. Accordingly, a column for such a categorical variable may include entries signifying type of concern such as, for example, payment-related concern, connectivity issue, data outage concern, and the like. An example of a numerical variable may be ‘amount of time spent in interaction.’ For example, a customer may have spent five minutes with an agent for resolving a query, whereas another customer may have spent twenty minutes for resolution of a similar query. Accordingly, transformation of data may involve standardizing and classifying various data types so they can be used as features to train machine learning algorithms to predict outcomes for existing and potential customers when they interact with the enterprise in future. In an example embodiment, the created columns may be directly used for training models.

It is noted some categorical variables may be associated with several levels. For example, the customers of the enterprise may use different Internet service providers (ISPs) for interacting with the enterprise. Creating a number of columns for a categorical variable ‘ISP’ may not only be cumbersome to manage, but the classification of data in such a manner may not provide any meaningful insight. Accordingly, in some embodiments, transformation of data may involve grouping several levels of a categorical variable into a more manageable group of levels.

In an embodiment, the transformation module 304 may be configured to perform three different types of algorithmic transformations, namely structured categorical variable binning, unstructured categorical variable binning, and numeric binning. In at least one example embodiment, the transformation module 304 may include several APIs for such algorithmic transformations of data.

In structured categorical variable binning, a set of APIs associated with the transformation module 304 is configured to invoke clustering algorithms to reduce cardinality of categorical variables. For example, different levels of categorical variables such as city, IP addresses, browsers, landing page categories, etc. may be grouped to a manageable set of levels that capture majority of the information. In at least some embodiments, supervised hierarchical clustering may be used for binary classification problems, where metrics such as weight of evidence and conversion rates are used for grouping similar levels of the categorical variable, for example metro cities may have similar conversions, suburb cities may have different conversions, and so on. The algorithmic transformations of data are used to create transformed variables in working datasets. More specifically, the data ingestion module 302 creates working datasets for each segment, whereas the transformation module 304 is configured to create transformed variables corresponding to the created working datasets. The transformed variables created may correspond to the training data sample and the testing data sample. The transformed variables corresponding to the training data sample may then be used to train machine learning algorithms to build predictive models.

In an embodiment, for unstructured categorical variable binning, the transformation module 304 may use text preprocessing options such as stop word removal, tokenization, and other algorithm options, such as Term Frequency Inverse Document Frequency (TFIDF), Singular Value Decomposition (SVD), Minimum Description Length (MDL), or other Information Theoretic approaches to convert unstructured data into structured data. The generation of transformed variables from the structured data may then be performed as explained above.

In an embodiment, for numeric binning, the transformation module 304 may be configured to invoke statistical and clustering techniques. For example, unsupervised techniques may be used to create variable bins based on data distribution (quantiles), and supervised techniques may be used to find optimal splits in the numerical scale, for example by using Chi Merge algorithm based approaches, for binning numeric data.

In an example embodiment, for each type of data transformational input, the transformation module 304 may be configured to perform at least one API action as exemplarily explained with reference to FIG. 5.

FIG. 5 shows a block diagram 500 for illustrating API actions executed by the transformation module 304 in response to inputs for various types of algorithmic transformations in accordance with an embodiment of the invention. More specifically, the block diagram 500 depicts a column 502 including a block 504 corresponding to an input, for example weight of evidence and cutoffs supported, for structured categorical variable binning; a block 506 corresponding to an input, for example text processing and Term Frequency-Inverse Document Frequency or TFIDF metrics, for unstructured categorical binning; and a block 508 for an input, for example weight of evidence, support, chi-square cutoffs, for numeric binning.

Further, the block diagram 500 depicts another column 510 including API actions executed by the transformation module 304 corresponding to each of those inputs. For example, blocks 512, 514, and 516 depict that API actions, in response to the input for structured categorical variable binning, may involve invoking clustering algorithms for reducing cardinality of structured categorical variables, creating transformed variables in working datasets, and creating transformation entities, for example creating columns corresponding to categorical variables that can be fed to data models, respectively. Blocks 518, 520, and 522 depict that API actions, in response to the input for unstructured categorical variable binning, may involve invoking natural language algorithms to convert unstructured data to structured data, creating transformed variables in working datasets, and creating transformation entities, respectively. Blocks 524, 526, and 528 depict that API actions, in response to the input for numeric binning, may involve invoking statistical and clustering techniques for numerical binning, creating transformed variables in working datasets, and creating transformation entities, respectively.

Referring now to FIG. 3, in at least one example embodiment, the model building module 306 is configured to build, i.e. train/generate, one or more predictive models using transformed variables generated using structured, unstructured, and numeric variable binning. As explained with reference to FIG. 1, the term ‘predictive model’ as used herein refers to machine learning or a statistical model configured to facilitate prediction of outcomes. Further, once the predictive models are built, a user may desire to test the predictive models to determine how good the predictive models are, prior to deploying the predictive models in their real-time prediction platform. Accordingly, the model validating module 308 may be configured to run simulations which mimic real-time customer behavior to facilitate scoring and metrics generation for the predictive models.

In an embodiment, the model building module 306 and the model validating module 308 include several APIs for model training, scoring, and generation of metrics. These APIs are configured to operate in two modes: train and predict modes. In the train mode, a user can specify variable selection criteria and balanced sampling options for training. In at least one embodiment, variable selection is automated through the use of information gain approach. As explained with reference to FIG. 1, a user may also specify the types of models that the user wants to build. Some non-limiting examples of such models may include regression models, clustering models, and classification models. For classification models, an option for specifying the data sampling strategy, i.e. under sampling of majority class also referred to as balanced sampling, may also be provisioned.

In at least one example embodiment, the APIs associated with the model building module 306 may be configured to facilitate an optimized threshold selection based on custom metrics specified by a user. The user may specify any number of model types to try out different model types and select the best one for their application. The model output may be stored in various model formats, depending on the model type and underlying user-defined functions (UDFs) being used. For R-based UDFs, the predictive model may be stored as an R object, and also exported to real time prediction entities in predictive model markup language (PMML) or JavaScript format.

In the train mode, based on user inputs such as specifications explained above, the model building module 306 may be configured to select appropriate machine learning models from a library of machine learning models stored in the memory 104 to train. The selected machine learning models may then be trained using the transformed variables corresponding to the training data sample to develop the predictive models.

Users may also specify the metrics they want to generate, such as receiver operating characteristics (ROC) curves, accuracy, confusion matrix, precision-recall for various threshold settings for the predictive models, and the like. Furthermore, the users may also specify a threshold cutoff strategy, i.e. maximum area under curve (AUC) or maximum recall, or any other custom optimization criteria. In an illustrative example, given the context of in-session targeting on a Web channel, a variable threshold selection strategy may be employed wherein different thresholds are set for each page visited. The variable threshold selection may be executed while accounting for a tradeoff between recall, precision, and accuracy.

In at least one example embodiment, in the predict mode, the transformed variables corresponding to the testing data sample may be used by the model validating module 308 to simulate real-time usage behavior of customers and perform testing and/or validation of the developed one or more predictive models. The models are scored based on comparison of the generated results from testing and the expected results known from observed behavior. In some embodiments, in the predict mode, previously generated models may be used to score new datasets. Such a feature is especially useful for scoring and metrics creation for newly obtained models or for evaluating previous models on new datasets.

In the predict mode, the user may specify the dataset to be scored with all the details of models for which scoring is desired and all the associated transformations. A metrics API configured to generate all the metrics, such as the metrics explained above with respect to the train mode, may also be included in the model building module 306 for the predict mode.

In an example embodiment, for each type of input, the model building module 306 in conjunction with the model validating module 308 may be configured to perform at least one API action as exemplarily explained with reference to FIG. 6.

FIG. 6 shows a block diagram 600 for illustrating API actions executed by the model building module 306 and the model validating module 308 in response to inputs corresponding to train and predict modes in accordance with an embodiment of the invention. More specifically, the block diagram 600 depicts a column 602 including a block 604 corresponding to a variable selection and balanced sampling input for the train mode; a block 606 corresponding to a type of model input, for example input related to a type of model from among a classification model, a regression model, a clustering model, and the like, and/or an input related to model parameters for the train mode; a block 608 for input related to desired metrics and threshold cutoff strategy for the train mode; a block 610 corresponding to a dataset, for example a dataset which is out of time or test, transform and model configurations input for the predict mode; and a block 612 corresponding to desired metrics for evaluation input, for the predict mode.

Further, the block diagram 600 depicts another column 614 including API actions executed by the model building module 306 and the model validating module 308 for each of those inputs. For example, block 616 depicts that an API action, in response to the input for train mode at block 604, may involve creating a new working dataset. Blocks 618 and 620 depict that API actions, in response to the input for the train mode at block 606, may involve invoking model training API, score training and testing of datasets, and storing model output in PMML/JavaScript format, respectively. Blocks 622 and 624 depict that API actions, in response to the input for the train mode at block 608, may involve invoking metrics and cutoff selection of APIs, and creating JavaScript post conditions for selected thresholds. Block 626 depicts that an API action, in response to the input for the predict mode at block 610, may involve reading stored model and scoring specified dataset. Block 628 depicts that an API action, in response to the input for the predict mode at block 612, may involve invoking metrics API and obtaining metrics.

Referring now to FIG. 3, in at least one example embodiment, the model publishing module 310 is configured to publish a predictive model based on scores and metrics generated corresponding to predictive models developed by the model building module 306 and scored using the model validating module 308. More specifically, based on scores and metrics generated corresponding to the predictive models, a suitable predictive model may be chosen for deployment onto a real-time prediction platform. In some example embodiments, the chosen predictive model may be deployed as-is, or alternatively, a user may fine-tune the chosen predictive model prior to its deployment. The model monitoring module 312 may then be configured to monitor the deployed predictive module and the model retraining module 314 may be configured to retrain the predictive model based on observed usage behavior upon deployment in a real-time user platform.

In an embodiment, the model publishing module 310, the model monitoring module 312, and the model retraining module 314 include a set of APIs for publishing, monitoring, and retraining the predictive model, respectively. In the publishing API, a user needs to specify a plurality of post model evaluation conditions that determine what call-to-actions need to be taken, depending on the model output. The model publishing module 310 publishes these conditions along with the transformations created in the project and the models in JavaScript or PMML formats to the end points specified and the transfer protocols. The end point could also be standalone, in which case model publishing module 310 may publish just the REST call to invoke prediction for a new data point. This standalone prediction API would include the data source, transformation, and scoring API's packaged as a single prediction workflow.

In the model monitoring API, new customer data that is fetched and stored in the memory 104 can be scored on a previously generated and published model, and metrics can be derived that report a PSI and a VSI. The model retraining module 314 also enables the users to configure daily or weekly email/SMS alerts on these metrics, and also configure retrain action that gets triggered if any of the monitoring metrics exceed a particular threshold. The retraining API would start the workflow again from problem definition step, for example operation 202 in process flow explained with reference to FIG. 2, but with new data, and previously saved settings for data sampling, transformation, model training, scoring, and metrics generation steps. The retraining API may also include options for users to receive emails or view results of the retrained models and how they compare with previous models.

In an example embodiment, for each type of input, the model publishing module 310, the model monitoring module 312, and the model retraining module 314 may be configured to perform at least one API action as exemplarily depicted in FIG. 7.

FIG. 7 shows a block diagram 700 for illustrating API actions executed by the model publishing module 310, the model monitoring module 312, and the model retraining module 314 in accordance with an embodiment of the invention. More specifically, the block diagram 700 depicts a column 702 including a block 704 corresponding to a user input specifying post conditions and desired response (Call-to-Action and the like); a block 706 corresponding to a user input specifying end point for prediction entities with specified transfer protocols; and a block 708 corresponding to a user input specifying data and model monitoring parameters, thresholds for email/SMS alerts, or automatic retrain action.

Further, the block diagram 700 depicts another column 710 including API actions executed by the model publishing module 310 and the model retraining module 312 corresponding to each of those inputs. For example, block 712 depicts that an API action, in response to the user input at block 704, may involve creating prediction entities that use model output. Block 714 depicts that an API action, in response to the user input at block 706, may involve creating chained prediction entity combining feature transforms, pre-conditions, models, and post conditions. If the end point is not standalone, then at block 716, in response to the input at block 706, an API action may involve using the specified transfer protocol to publish entities. Blocks 718 and 720 depict that API actions, in response to the user input at block 708 may involve creating a scheduled prediction service where new data is scored automatically, and computing metrics specified for monitoring and storing in database. Further specified action is invoked and retraining creates a new set of models.

Referring now to FIG. 1, in at least one embodiment, the apparatus 100 may be used both in ‘on-demand’ and ‘automated’ modes. In the ‘on-demand’ mode users may serially build the workflow by configuring every single step and experimenting with different input settings. Once the settings are defined for each step, the apparatus 100 may be configured to switch to an ‘automated’ mode, whereby the workflow may be scheduled on a regular basis, monitoring results may be obtained and automated retraining may be configured.

As explained, the predictive models may be built with an objective in mind. In an illustrative example, a user may wish to build a predictive model for credit modeling purpose. According, the user may provide the problem definition and also identify data sources storing data of customers associated with a financial enterprise, such as a bank for instance. The user may also serially build the prediction workflow for providing appropriate inputs, such as segments to consider, for example only credit card customers or housing loan customers, and the like; data sampling options; selection of variables; type of model; and the like. The apparatus 100 may receive such input and execute corresponding API actions, such as the API actions explained with reference to FIGS. 4 to 7, to develop a predictive model, which may then be deployed in a real-time prediction platform. The user may use the predictive model to predict if current or future customers of the financial enterprise are high risk or low risk, whether the customer can be availed a loan or not, and the like. The automated prediction workflow as provisioned by the customer may similarly be used for building other predictive models, such as those for predicting customer intentions, for spam or fraud detection, and the like.

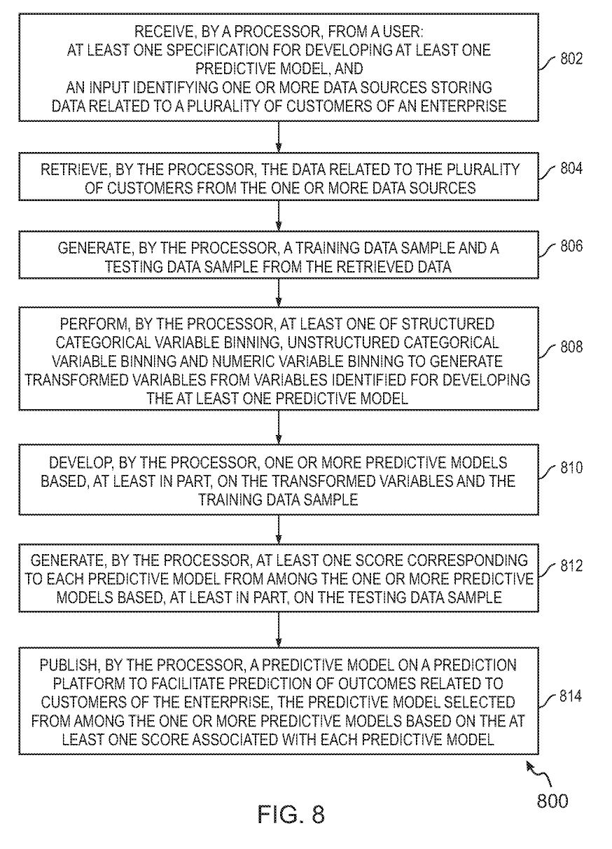

A method for facilitating on-demand building of predictive models is explained with reference to FIG. 8.

FIG. 8 is a flow diagram of an example method 800 for managing natural language queries of customers in accordance with an embodiment of the invention. The method 800 depicted in the flow diagram may be executed by, for example, the apparatus 100 explained with reference to FIGS. 1 to 7. Operations of the flowchart, and combinations of operation in the flowchart, may be implemented by, for example, hardware, firmware, a processor, circuitry, and/or a different device associated with the execution of software that includes one or more computer program instructions. The operations of the method 800 are described herein with help of the apparatus 100. For example, one or more operations corresponding to the method 800 may be executed by a processor, such as the processor 102 of the apparatus 100. Although the one or more operations are explained herein to be executed by the processor alone, it is understood that the processor is associated with a memory, such as the memory 104 of the apparatus 100, which is configured to store machine executable instructions for facilitating the execution of the one or more operations. Also, the operations of the method 800 can be described and/or practiced by using an apparatus other than the apparatus 100. The method 800 starts at operation 802.

At operation 802 of the method 800, at least one specification for developing at least one predictive model is received from a user. The term ‘user’ as used herein may refer to a human representative of the enterprise, for example a software manager, tasked with predicting outcomes for plurality of customers of the enterprise. In an embodiment, a specification may relate to a problem definition for developing the predictive model. The problem definition may be indicative of an objective of the user for developing the predictive model. More specifically, the problem definition may describe a problem that the user intends to solve using the predictive model. Some non-exhaustive examples of user objectives for building the predictive models include customer intent prediction, spam or fraud detection for e-commerce applications, customer credit risk modeling or customer lead scoring for traditional applications, and the like.

In one embodiment, a received specification may correspond to a discrete outcome to be predicted for each customer by the predictive model. Some examples of the discrete outcomes may include buy/no-buy outcome, the spam/no-spam communication outcome, whether a customer is high risk/low risk customer, whether a customer is a potential lead or a stump, and the like.

In one embodiment, a specification may correspond to one or more customer segments to be considered for prediction by the predictive model. In an embodiment, the specification corresponding to the one or more customer segments to be considered may further include instructions corresponding to pre-conditions for individual segments. The segments to be considered and the pre-conditions associated with the segments are explained with reference to FIG. 1 and are not explained herein.

In some embodiments, a user may also specify data sampling options for model building and validation through specification of a sampling ratio.

Further, an input identifying one or more data sources storing data related to a plurality of customers of an enterprise may also be received from the user. At operation 804 of the method 800, data related to a plurality of customers of an enterprise is retrieved from one or more data sources.

At operation 806 of the method 800, a training data sample and a testing data sample are generated from the retrieved data. As explained above, the user may provide an input related to a sampling ratio. In at least one example embodiment, the retrieved data may be split to generate the training data sample and the testing data sample.

Further, in some embodiments, variables that may be used for developing the predictive models may be identified from the retrieved data. The identification of the variables may be performed as explained with reference to FIG. 1 and is not explained again herein.

At operation 808 of the method 800, at least one of structured categorical variable binning, unstructured categorical variable binning, and numeric variable binning is performed to generate transformed variables from the variables identified for developing the at least one predictive model. The generation of transformed variables may be performed as explained with reference to FIGS. 1 and 5.

At operation 810 of the method 800, one or more predictive models based, at least in part, on the transformed variables and the training data sample. At operation 812 of the method 800, at least one score corresponding to each predictive model from among the one or more predictive models is generated based, at least in part, on the testing data sample. The development of predictive models and the generation of scores for each of the predictive models may be performed as explained with reference to FIGS. 1 and 6 and is not explained again herein.

At operation 814 of the method 800, a predictive model is published on a prediction platform to facilitate prediction of outcomes related to customers of the enterprise. The predictive model is selected from among the one or more predictive models based on the at least one score associated with each predictive model. The publishing of the predictive model may be performed as explained with reference to FIGS. 1 and 7.

Various embodiments disclosed herein provide numerous advantages. More specifically, techniques are disclosed herein for facilitating on-demand building and deployment of predictive models. In some embodiments, the techniques disclosed herein may be implemented as a set of APIs configured to facilitate ‘prediction as a service’ for automated intent prediction and scoring for offline and online customer relationship management (CRM) and e-commerce applications.

Various embodiments disclosed herein provide a holistic set of options for feature engineering, machine learning model training, monitoring and deployment, combined with business rules specifications. Various supervised and unsupervised techniques to deal with structured but high cardinality data (IP's), information theoretic approaches to deal with semi-structured data, e.g. Web page content such as URL's, and text mining techniques to deal with unstructured data, e.g. chat logs, are also disclosed.

Furthermore, various model training and custom metrics generation options are provided along with business rules, where users can simulate near real time behavior offline. The model simulation and custom metrics generation options are generally not available in third party or open source tools. Moreover, such an end-to-end solution is feature rich in terms of dealing with different kinds of data, performing different types of feature transformations, providing different options for model training, which predominantly include but not limited to classifier technology for intent predictions, and creation of chained prediction entities for real time scoring applications using a combination of Java-based transformations and Prediction Model Markup Language (PMML)-based models.

Furthermore, end users of the solution provided herein are spared the effort of having to write proprietary code for processing different forms of data and additional custom code to port these proprietary codes in their real-time platforms. Also, the disclosed embodiments enable the user to specify a personal data transformation logic, such as customer segments, business rules to describe qualification criteria for prediction, and additional business rules that determine call-to-action rules, e.g. offer a chat invite to a customer on a Website or display a banner/widget once a model score exceeds a threshold.

Although the present invention has been described with reference to specific exemplary embodiments, it is noted that various modifications and changes may be made to these embodiments without departing from the broad spirit and scope of the invention. For example, the various operations, blocks, etc. described herein may be enabled and operated using hardware circuitry, for example complementary metal oxide semiconductor (CMOS) based logic circuitry, firmware, software, and/or any combination of hardware, firmware, and/or software, for example embodied in a machine-readable medium. For example, the apparatuses and methods may be embodied using transistors, logic gates, and electrical circuits, for example, application specific integrated circuit (ASIC) circuitry and/or in Digital Signal Processor (DSP) circuitry.

Particularly, the apparatus 100, the processor 102, the memory 104, the I/O module 106, the communication interface 108, and the various modules such as the data ingestion module 302, the transformation module 304, the model building module 306, the model validating module 308, the model publishing module 310, the model monitoring module 312, and the model retraining module 314 may be enabled using software and/or using transistors, logic gates, and electrical circuits, for example integrated circuit circuitry such as ASIC circuitry. Various embodiments of the present invention may include one or more computer programs stored or otherwise embodied on a computer-readable medium, wherein the computer programs are configured to cause a processor or computer to perform one or more operations, for example operations explained herein with reference to FIGS. 2 and 6. A computer-readable medium storing, embodying, or encoded with a computer program, or similar language, may be embodied as a tangible data storage device storing one or more software programs that are configured to cause a processor or a computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media, such as floppy disks, magnetic tapes, hard disk drives, etc.; optical magnetic storage media, e.g. magneto-optical disks; CD-ROM (compact disc read only memory); CD-R (compact disc recordable); CD-R/W (compact disc rewritable); DVD (Digital Versatile Disc); BD (BLU-RAY® Disc); and semiconductor memories, such as mask ROM, PROM (programmable ROM), EPROM (erasable PROM), flash memory, RAM (random access memory), etc. Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line, e.g. electric wires, and optical fibers, or a wireless communication line.

Various embodiments of the present invention, as discussed above, may be practiced with steps and/or operations in a different order, and/or with hardware elements in configurations, which are different than those which, are disclosed. Therefore, although the technology has been described based upon these exemplary embodiments, certain modifications, variations, and alternative constructions may be apparent and well within the spirit and scope of the invention.

Although various exemplary embodiments of the present invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
receiving, by a processor, from a user:
at least one specification for developing at least one predictive model, and
an input identifying one or more data sources storing data related to a plurality of customers of an enterprise;
retrieving, by the processor, the data related to the plurality of customers from the one or more data sources;
generating, by the processor, a training data sample and a testing data sample from the retrieved data;
performing, by the processor, at least one of structured categorical variable binning, unstructured categorical variable binning, and numeric variable binning;
generating, by the processor, transformed variables from variables identified for developing the at least one predictive model;
developing, by the processor, one or more predictive models based, at least in part, on the transformed variables and the training data sample;
generating, by the processor, at least one score corresponding to each predictive model from among the one or more predictive models based, at least in part, on the testing data sample;
selecting, by the processor, a predictive model from among the one or more predictive models based on the at least one score associated with each predictive model;
publishing the predictive model, by the processor, on a prediction platform; and
applying, by the processor, the published predictive model to predict outcomes related to customers of the enterprise.

2. The method of claim 1, wherein a specification from among the at least one specification comprises a problem definition for developing the at least one predictive model, the problem definition comprising an objective of the user for developing the at least one predictive model.

3. The method of claim 2, wherein the objective comprises any of customer intent prediction, spam or fraud detection, customer credit risk modelling, and customer lead scoring.

4. The method of claim 1, wherein a specification from among the at least one specification comprises a discrete outcome to be predicted for each customer among one or more customers of the enterprise by the at least one predictive model.

5. The method of claim 1, wherein a specification from among the at least one specification comprises one or more customer segments to be considered for prediction by the at least one predictive model.

6. The method of claim 5, wherein the specification corresponding to the one or more customer segments to be considered further comprises one or more pre-conditions for at least one customer segment from among the one or more customer segments.

7. The method of claim 1, wherein a specification from among the at least one specification comprises a sampling ratio for sampling the retrieved data to generate the training data sample and the testing data sample.

8. The method of claim 1, further comprising:
performing the identification of variables for developing the at least one predictive model based on one of user inputs specifying custom variables and pre-defined variables in the retrieved data.

9. The method of claim 1, further comprising:
subjecting one or more variables corresponding to structured categorical variables from among the identified variables to at least one clustering algorithm to perform the structured categorical variable binning, the structured categorical variable binning reducing cardinality associated with the structured categorical variables.

10. The method of claim 1, further comprising:
converting unstructured data from among the retrieved data to structured data using natural language language algorithms to facilitate the unstructured categorical variable binning.

11. The method of claim 1, further comprising:
subjecting one or more variables corresponding to numeric variables from among the identified variables to at least one of a statistical algorithm and a clustering algorithm to perform the numeric variable binning, the numeric variable binning reducing cardinality associated with the numeric variables.

12. The method of claim 1, wherein developing the one or more predictive models comprises:
receiving user input related to any of:
variables to be selected from among the transformed variables;
at least one type of machine learning algorithm to be used for developing the one or more predictive models; and
metrics to be evaluated corresponding to the one or more predictive models; and
training, by the processor, the at least type one machine learning algorithm based on the transformed variables, the training data sample, and the user input, the training of the at least one machine learning algorithm causing development of the one or more predictive models.

13. The method of claim 1, further comprising:
monitoring, by the processor, a real-time usage behavior of the published predictive model subsequent to the publishing of the predictive model on the prediction platform.

14. The method of claim 13, wherein monitoring the real-time usage behaviour comprises generating scores related to at least one metric from among Popularity Stability Index (PSI) and Variable Stability Index (VSI).

15. The method of claim 14, further comprising:
triggering, by the processor, retraining of the published predictive model when a generated score corresponding to one of the PSI and the VSI is less than a predefined threshold value.

16. The method of claim 1, further comprising:
facilitating on-demand building of predictive models by providing an automated prediction workflow to the user to implement and execute the steps of retrieving, generating, performing, developing, generating, and publishing.

17. The method of claim 16, further comprising:
executing each step of the automated prediction workflow the processor using one or more Application Programming Interfaces (APIs).

18. An apparatus, comprising:
an input/output (I/O) module configured to receive from a user:
at least one specification for developing at least one predictive model, and
an input identifying one or more data sources storing data related to a plurality of customers of an enterprise;
a communication interface communicably coupled with the I/O module, the communication interface configured to retrieve the data related to the plurality of customers from the one or more data sources;
at least one processor; and
a memory having stored therein machine executable instructions, that when executed by the at least one processor, cause the apparatus to:
generate a training data sample and a testing data sample from the retrieved data;
perform any of structured categorical variable binning, unstructured categorical variable binning, and numeric variable binning;
generate transformed variables from variables identified for developing the at least one predictive model;
develop one or more predictive models based, at least in part, on the transformed variables and the training data sample;
generate at least one score corresponding to each predictive model from among the one or more predictive models based, at least in part, on the testing data sample;
select a predictive model from among the one or more predictive models based on the at least one score associated with each predictive model;
publish the predictive model on a prediction platform; and
apply the published predictive model to predict outcomes related to customers of the enterprise.

19. The apparatus of claim 18, wherein a specification from among the at least one specification comprises a problem definition for developing the at least one predictive model, the problem definition comprising an objective of the user for developing the at least one predictive model.

20. The apparatus of claim 18, wherein a specification from among the at least one specification comprises a discrete outcome to be predicted corresponding to each customer from among one or more customers of the enterprise by the at least one predictive model.

21. The apparatus of claim 18, wherein a specification from among the at least one specification comprises one or more customer segments to be considered for prediction by the at least one predictive model, the specification further comprising one or more pre-conditions for at least one customer segment from among the one or more customer segments.

22. The apparatus of claim 18, wherein a specification from among the at least one specification comprises a sampling ratio for sampling the retrieved data to generate the training data sample and the testing data sample.

23. The apparatus of claim 18, wherein for performing the structured categorical variable binning, the apparatus is further caused to:
subject one or more variables corresponding to structured categorical variables from among the identified variables to at least one clustering algorithm, the structured categorical variable binning reducing cardinality associated with the structured categorical variables.

24. The apparatus of claim 18, wherein for performing the unstructured categorical variable binning, the apparatus is further caused to:
use natural language language algorithms to convert unstructured data from among the retrieved data to structured data.

25. The apparatus of claim 18, wherein for performing the numeric variable binning, the apparatus is further caused to:
subject one or more variables corresponding to numeric variables from among the identified variables to at least one of a statistical algorithm and a clustering algorithm, the numeric variable binning reducing cardinality associated with the numeric variables.

26. The apparatus of claim 18, wherein the apparatus is further caused to:
monitor a real-time usage behavior of the published predictive model subsequent to the publishing of the predictive model on the prediction platform; and
generate scores related to at least one metric from among Popularity Stability Index (PSI) and Variable Stability Index (VSI).

27. The apparatus of claim 26, wherein the apparatus is further caused to:
trigger retraining of the published predictive model when a generated score comprising one of the PSI and the VSI is less than a predefined threshold value.

28. An apparatus, comprising:
an input/output (I/O) module configured to receive from a user:
at least one specification for developing at least one predictive model, and
an input identifying one or more data sources storing data related to a plurality of customers of an enterprise;
a communication interface communicably coupled with the I/O module, the communication interface configured to facilitate retrieval of the data related to the plurality of customers from the one or more data sources;
a data ingestion module configured to generate a training data sample and a testing data sample from the retrieved data;
a transformation module configured to perform at least one of structured categorical variable binning, unstructured categorical variable binning, and numeric variable binning to generate transformed variables from variables identified for developing the at least one predictive model;
a model building module configured to develop one or more predictive models based, at least in part, on the transformed variables and the training data sample;
a model validating module configured to generate at least one score corresponding to each predictive model from among the one or more predictive models based, at least in part, on the testing data sample; and
a model publishing module configured to publish a predictive model on a prediction platform to facilitate prediction of outcomes related to customers of the enterprise, the predictive model selected from among the one or more predictive models based on the at least one score associated with each predictive model.

29. The apparatus of claim 28, wherein a specification from among the at least one specification comprises a problem definition for developing the at least one predictive model, the problem definition comprising an objective of the user for developing the at least one predictive model.

30. The apparatus of claim 28, wherein a specification from among the at least one specification comprises a discrete outcome to be predicted corresponding to each customer from among one or more customers of the enterprise by the at least one predictive model.

31. The apparatus of claim 28, further comprising:
a model monitoring module configured to monitor a real-time usage behavior of the published predictive model subsequent to the publishing of the predictive model on the prediction platform; and
a model retraining module configured to retrain the predictive model based on observed deviations during monitoring the real-time usage behavior of the published at least one predictive model.

32. The apparatus of claim 31, wherein each module from among the data ingestion module, the transformation module, the model building module, the model validation module, the model publishing module, the model monitoring module, and the model retraining module comprises one or more Application Programming Interfaces (APIs) to facilitate execution of respective tasks.

33. The apparatus of claim 32, the one or more APIs associated with the each module further comprising:
an automated prediction workflow provided to the user to facilitate on-demand building of predictive models.
